(19) United States
(12) Patent Application Publication
(10) Pub. No.: US 2011/0289539 A1
(43) Pub. Date: Nov. 24, 2011

(54) Multimedia content production and distribution platform

(76) Inventor: Kim Sarubbi, Los Angeles, CA (US)

(21) Appl. No.: 12/800,713

(22) Filed: May 19, 2010

(51) Int. Cl. H04N 7/173

(52) U.S. Cl. 725/109

(57) ABSTRACT

A system for producing and distributing multimedia content. The inventive system includes a camera at a remote shooting location for generating a video feed, a first mechanism for distributing the video feed to a plurality of viewers, a second mechanism for receiving inputs regarding a content of the video feed from the viewers, and a third mechanism for creating the video feed in accordance with the viewer inputs. In an illustrative embodiment, the system includes a distribution server for transmitting the video feed and a web server adapted to receive the viewer inputs and in accordance therewith generate a control signal or message to create the desired content indicated by the viewer inputs. In a particular embodiment, the viewer inputs are used to control the camera filming the video feed, either automatically via electronic control signals or via a text message, web pop-up, or other notification to the camera operator.

### BACKGROUND OF THE INVENTION

1. Field of the Invention

The present invention relates to client-server network systems. More specifically, the present invention relates to systems and methods for producing and distributing multimedia content.

2. Description of the Related Art

Many people, including film students and amateur filmmakers, are interested in learning what happens behind the scenes during the production of a movie or other multimedia work. Film and television production is typically a complex and expensive process involving a large number of people including the cast, camera operators, lighting and sound crews, directors and assistant directors, etc. Learning the filmmaking trade can therefore be difficult and expensive.

DVDs often include some behind the scenes footage, usually including commentary from the film director or various cast or production members. These videos give some insight into the filmmaking process but are generally limited to only a few aspects of film production and may not show everything a student or film enthusiast would like to see or learn about.

The best way to learn about film or television production would be to actively participate in the production of a movie or television show, or to be present on an actual film/television set where one can observe the different aspects of production. However, film sets are usually closed to the public, and most people do not have access to either participate in or to just observe the production of an actual film.

Hence, a need remains in the art for a system or method for enabling users to participate in the production of a multimedia work that is less expensive and more accessible than a conventional filmmaking process.

### SUMMARY OF THE INVENTION

The need in the art is addressed by the system for producing and distributing multimedia content of the present invention. The inventive system includes a camera at a remote shooting location for generating a video feed, a first mechanism for distributing the video feed to a plurality of viewers, a second mechanism for receiving inputs regarding a content of the video feed from the viewers, and a third mechanism for creating the video feed in accordance with the viewer inputs. In an illustrative embodiment, the system includes a distribution server for transmitting the video feed to viewers over the interne and a web server running software adapted to receive the viewer inputs and in accordance therewith generate a control signal or message to create the desired content indicated by the viewer inputs. In a particular embodiment, the viewer inputs are used to control the camera filming the video feed, either automatically via electronic control signals or via a text message, web pop-up, or other notification to the camera operator. The viewer inputs may also be used to control aspects of film production.

### BRIEF DESCRIPTION OF THE DRAWINGS

FIG. 1 is a simplified block diagram of a multimedia production and distribution system in accordance with an illustrative embodiment of the present teachings.

FIG. 2 is an example screenshot of a viewer web portal in accordance with an illustrative embodiment of the present teachings.

FIG. 3 is a simplified flow chart of the user-based content control in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel platform for producing and distributing multimedia content that enables viewers to participate in the creation of the content. In particular, the system allows users to control one or more cameras filming the content, either via a voting process or taking turns according to a time-share schedule. The system also includes two-way communication between viewers and the production staff, allowing viewers to ask questions or make requests (e.g., to the film director or camera operator). Optionally, the viewers may also contribute to other aspects of content production such as casting, lighting, etc.

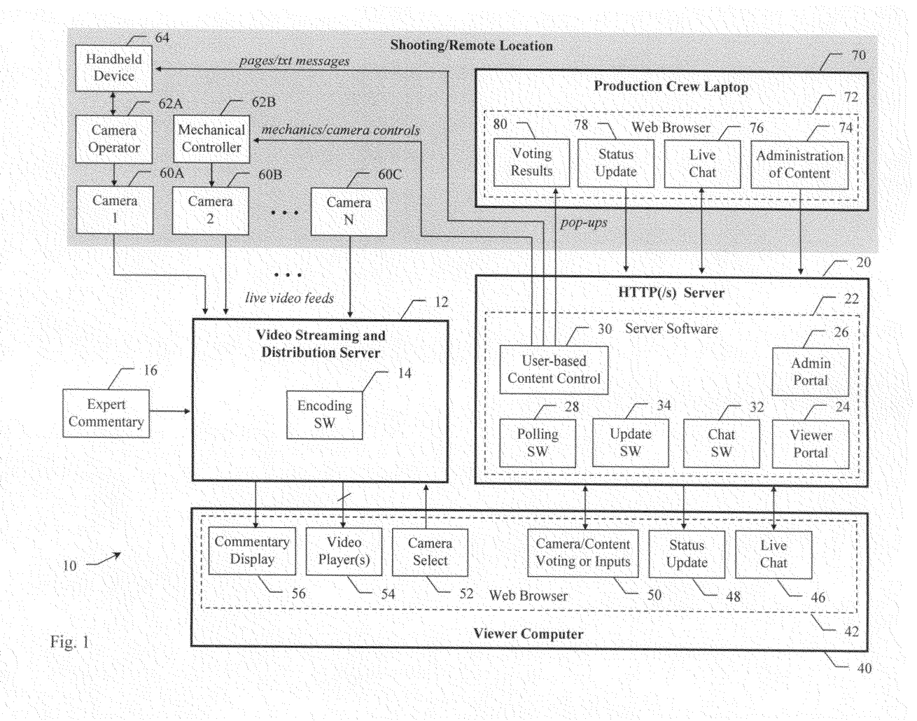

FIG. 1 is a simplified block diagram of a multimedia production and distribution system 10 in accordance with an illustrative embodiment of the present teachings. The system 10 includes a video streaming and distribution server 12 and a web server 20. The video distribution server 12 receives one or more live video feeds from a remote shooting location and distributes the video feeds to a plurality of viewers via the internet. The web server 20 provides a web portal 24 for viewers to log in and view the video feeds from the video distribution server 12 on their personal computers 40, and to provide inputs for steering the content of the live video feeds. The web server 20 receives the viewer inputs and generates control signals and/or messages that are transmitted to the remote shooting location to control the filmed content accordingly.

The remote shooting location may be a studio sound stage or other film set for filming the multimedia content. A plurality of cameras 60 at the shooting location provides the live video feeds. In accordance with the present teachings, the multimedia system 10 includes a user-based camera control system 30 for steering at least one camera 60 on the set in accordance with inputs from the viewers. Camera control may be fully automated using mechanical controls, or the camera may be controlled by a human operator that receives instructions from the system 30.

Three cameras 60A, 60B, and 60C are shown in the illustrative embodiment of FIG. 1. A first camera 60A is controlled by a human operator 62A. The camera operator 62A is notified of viewer instructions via a handheld device 64, such as a cellular phone, PDA (personal digital assistant), or pager, or a laptop computer 70. Alternatively, camera control may be fully automated. For example, in FIG. 1, a second camera 60B is mounted on a mechanical gimbal and platform for rotating and moving the camera in response to electrical control signals from the user-based camera controller 30. The user-based controller 30 may also generate control signals for adjusting camera settings such as focal length (zoom). The system 10 may also include one or more static cameras, such as the third camera 60C, which have a fixed position. In an illustrative example, a plurality of wide angle fixed cameras are scattered throughout the set to provide live feeds of different parts of the set. Viewers can then use these static feeds to determine where to send a roving camera 60A.

The video outputs from each camera are transmitted to the video distribution server 12. The video distribution server 12 may include software 14 for encoding the live feeds for transmission over the internet and, upon request from a viewer's computer, distributing the encoded feed thereto. Optionally, the video distribution server 12 may also receive and distribute a video or audio feed 16 containing live commentary from an expert (such as a professor or other expert commenting on various technical aspects of the film production). The live commentary feed may originate from the shooting location or from another remote location.

In the illustrative embodiment, viewers participate in the content of the video feeds through the web server 20. In a preferred embodiment, a plurality of viewers collectively steer the content through a voting process. For example, a production staff member may initiate a poll asking viewers what the roving camera 60A should be filming, giving the viewers multiple selections to choose from such as follow the director, or a particular actor, or focus on a particular part of the set, etc. Alternatively, one viewer may be given direct content control during a particular time according to a “time share” schedule.

The web server 20 includes software 22 for implementing the user-controlled content system. The server 20 includes a viewer web portal 24 that is accessible to viewers via a web browser 42 running on a personal computer, and an administrative portal 26 that is accessible to the production staff via a web browser 72 running on a computer 70 on the set. The server 20 includes polling software 28 for counting votes from the viewers and directing the results to a content control function 30. The content control function 30 generates and transmits control signals or messages to the shooting location in response to the voting results. The content controller 30 may generate different types of signals/messages depending on what is being controlled. For example, the content controller 30 may generate control signals for automatically adjusting a mechanically controlled camera 60B, or the content controller 30 may send a message describing the viewers' request to the appropriate production staff member (such as the camera operator or the director) via, for example, an event notification pop-up 80 on the administrative web portal, or a page or text message to a mobile phone belonging to the staff member. In a preferred embodiment, the viewer requests are implemented in real-time, while the cameras 60 are streaming live feeds.

In a preferred embodiment, the server 20 also includes chat software 32 for running a live chat session between the viewers and the production staff, allowing viewers to ask questions to the staff. The server 20 may also include software 34 for updating and displaying the current status of various production staff members (such as the camera operator) to the viewers based on input from the production staff.

The administrative web portal 26 includes a user interface 74 for allowing a production staff member or other administrator to specify system parameters including poll parameters (such as what the poll is for, the selections viewers can choose from, when the poll should start, the duration of the poll, whom to notify with the poll results, etc.). The administrative web portal 26 may also include a live chat window 76 and an input form 78 for updating the status of certain production members.

On the viewer side, the viewer web portal 24 displays one or more of the live video feeds (using a video player plug-in 54 running on the viewer's computer 40). In a preferred embodiment, several video feeds are transmitted from the video distribution server 12, and the web portal 24 includes a user interface 52 for allowing the viewer to select which feed or feeds to view. Optionally, the video player 54 may include a “picture in picture” function allowing more than one feed to be displayed simultaneously. The viewer web portal 24 may also include a display 56 for viewing the expert commentary, which may be another video feed, an audio feed, or just text.

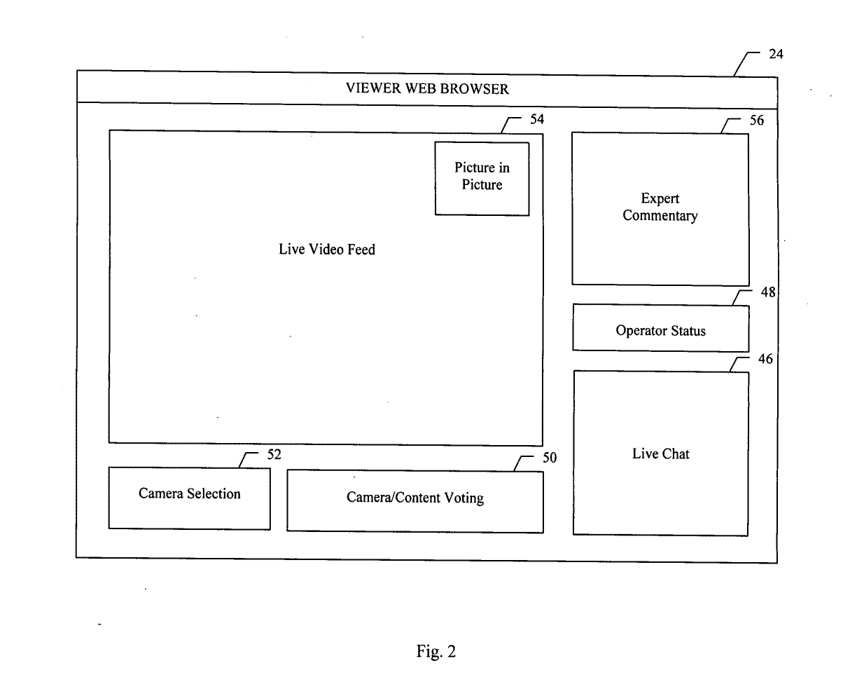

The viewer web portal 24 also includes a user interface 50 for voting on content or otherwise providing inputs for controlling the content of the live feeds. The viewer web portal 24 may also include a live chat window 46 for interacting with other viewers and/or the production staff and a display 48 for displaying the current status of various production members. See FIG. 2, which shows an example screenshot of a viewer web portal 24 in accordance with an illustrative embodiment of the present teachings.

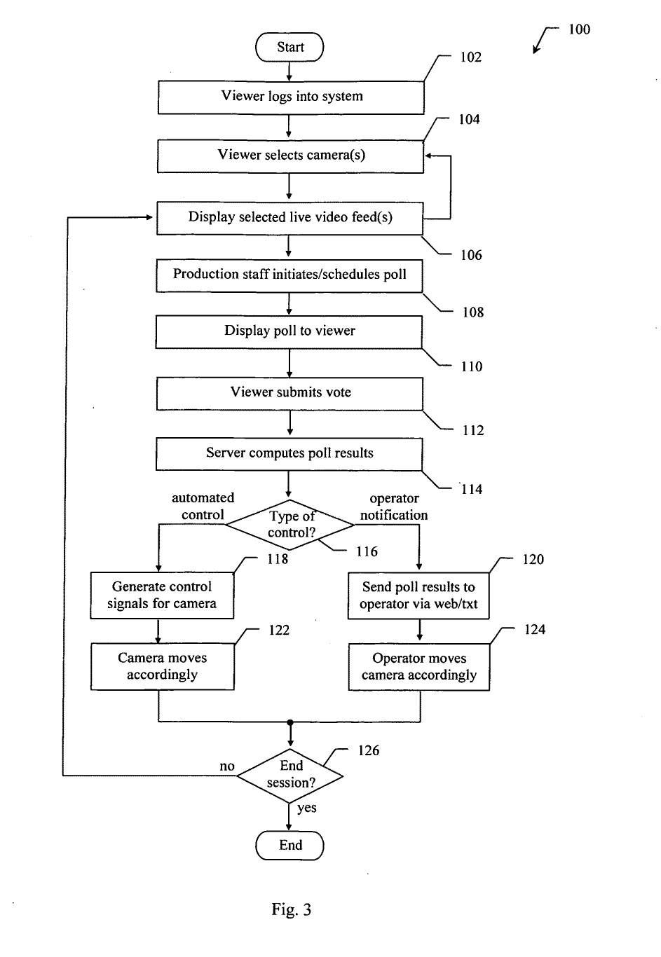

FIG. 3 is a simplified flow chart of the user-based content control 100 in accordance with an illustrative embodiment of the present teachings. In operation, first at Step 102, a viewer logs into the system via a web browser, which displays the viewer web portal.

At Step 104, the viewer selects which camera(s) to display, and at Step 106, the live video feed(s) from the selected camera(s) is displayed by the video player embedded in the viewer web portal. The viewer can switch cameras at any time.

At Step 108, a poll is initiated or scheduled by the production staff (via the administrative web portal). At Step 110, the poll is displayed to the viewer, showing the voting options and the duration of the vote.

At Step 112, the viewer submits a vote. At Step 114, the web server receives the viewer's vote and computes the poll results. Optionally, the results of the voting may be displayed to the viewer.

At Step 116, after the voting ends (based on the poll duration specified by the production staff at Step 108), the server sends the final results of the poll to the user-based content controller, which determines how to implement the poll results (as specified by the production staff at Step 108). In the illustrative embodiment, at Step 118, the user-based content controller generates control signals for an automated system (such as for a mechanically controlled camera), or at Step 120, the content controller sends the poll results to the appropriate production staff (such as the camera operator) via a text message or pop-up web notification.

At Step 122, the mechanically controlled camera moves in response to the control signals generated in Step 118, or at Step 124, the production staff member that was notified of the poll results in Step 120 implements the poll results (for example, the camera operator moves the camera in accordance with the poll results). Thus, the content of the live video feed is changed in accordance with the viewers' inputs.

This process then repeats for the next polls, until the viewer logs out of the system at Step 126.

In a first illustrative embodiment, the novel multimedia production and distribution system of the present invention is used in an educational application to film behind the scenes content of a movie shoot. In this embodiment, two sets of cameras are present at the shooting location: a first set of cameras for recording the actual movie footage (these cameras are not controlled by the viewers, but their feeds may optionally be streamed through the same distribution system) and a second set of cameras for shooting the behind the scenes footage (these cameras are controllable by the viewers). In a preferred embodiment, a production member (who may be the roving camera operator) continually monitors the administrative web site for requests from the viewers and implements those requests (such as changing the shot of the roving camera and/or asking questions of various production members).

In a second illustrative embodiment, the inventive system is used to enable viewers to participate in the production of the actual movie. In this embodiment, viewers can control the position and settings of the cameras shooting the film footage. The viewers may also be allowed to control lighting and wardrobe choices, issue acting directions, vote on casting or script versions, select from different takes of a scene, etc. Optionally, the system may offer different tiers of service to the viewers, allowing them access to different parts of the system (e.g., different voting privileges) depending on the service tier purchased.

In a preferred embodiment, the system may be used as part of a course in an online film school, with participants receiving college credit and being graded on their participation and/or the final product (e.g., the film created by the participants using the inventive system).

Thus, the present invention has been described herein with reference to a particular embodiment for a particular application. Those having ordinary skill in the art and access to the present teachings will recognize additional modifications, applications and embodiments within the scope thereof. For example, while the illustrative embodiments have been described with reference to a movie production, the inventive system may also be used for other types of multimedia works such as television, video, commercials, etc.

It is therefore intended by the appended claims to cover any and all such applications, modifications and embodiments within the scope of the present invention.

Accordingly,

What is claimed is:

1. A system for producing and distributing multimedia content comprising:
a camera at a remote shooting location for generating a video feed;
first means for distributing said video feed to a plurality of viewers;
second means for receiving inputs regarding a content of said video feed from said viewers; and
third means for creating said video feed in accordance with said viewer inputs.

2. The invention of claim 1 wherein said second means includes means for initiating a poll and receiving votes from said viewers.

3. The invention of claim 2 wherein said third means includes means for filming said video feed in accordance with a result of said votes.

4. The invention of claim 1 wherein said third means includes means for generating and sending a message about said viewer inputs to a predetermined individual.

5. The invention of claim 4 wherein said third means sends a text message to a mobile phone.

6. The invention of claim 4 wherein said third means sends a message via a web site.

7. The invention of claim 1 wherein said third means includes means for controlling said camera in accordance with said viewer inputs.

8. The invention of claim 7 wherein said third means includes means for generating a control signal for automatically controlling said camera.

9. The invention of claim 8 wherein said third means includes means for generating and sending a message about said viewer inputs to a camera operator.

10. The invention of claim 1 wherein said system further includes fourth means for live communication between said viewers and production staff at said remote shooting location.

11. The invention of claim 10 wherein said fourth means includes chat software.

12. The invention of claim 1 wherein said first means includes a distribution server.

13. The invention of claim 1 wherein said second means includes a web site running on a web server.

14. The invention of claim 13 wherein said third means includes software running on said web server adapted to receive said user inputs and in accordance therewith generate a control signal or message.

15. The invention of claim 1 wherein said video feed is a live video feed and said viewer inputs are implemented in real time.

16. A system for producing and distributing multimedia content comprising:
a camera at a remote shooting location for generating a video feed;
a distribution server for distributing said video feed to a plurality of viewers; and
a web server adapted to receive inputs regarding a content of said video feed from said viewers and in accordance therewith generate a control signal or message such that said video feed is created in accordance with said viewer inputs.

17. A method for producing and distributing multimedia content including the steps of:
generating a video feed;
distributing said video feed to a plurality of viewers;
receiving inputs regarding a content of said video feed from said viewers; and
creating said video feed in accordance with said viewer inputs.
